(19) United States
(12) Patent Application Publication
(10) Pub. No.: US 2009/0003143 A1
(43) Pub. Date: Jan. 1, 2009

(54) Recording Medium, Recording/Reproduction Apparatus and Replay Apparatus

(76) Inventors: Kazuaki Toba, Kanagawa (JP); Gen Ichimura, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/718,885

(22) PCT Filed: Sep. 8, 2006
(86) PCT No.: PCT/JP2006/317912

§ 371 Date: Sep. 5, 2008

(30) Foreign Application Priority Data
Sep. 9, 2005 (JP) 2005-262613

(51) Int. Cl. G11B 21/08; G11B 7/26

(52) U.S. Cl. 369/30.01; 369/272.1; G9B/17.002

(57) ABSTRACT

A recording medium that technically makes it not only impossible to infringe copyrights but possible for a buyer who properly bought contents to personally freely reproduce and enjoy the contents. A recording medium comprises a first recording region (3) where the contents encrypted by a contents key are recorded in advance, a second recording region (5) where a data providing a basis for the contents key is recorded in advance and a third recording region (4) that allows the encrypted contents key obtained by encrypting the contents key generated from the data providing a basis for the contents key by means of identification information on a user to be recorded therein.

### TECHNICAL FIELD

This invention relates to a recording medium for recording encrypted contents data. The present invention also relates to a recording/reproduction apparatus for writing data on a recording medium where encrypted contents data are recorded. The present invention further relates to a replay apparatus for replaying a recording medium on which encrypted contents data are recorded.

This application is based upon and claims the benefit of priority from the prior Japanese Patent Application JP 2005-262613, filed on Sep. 9, 2005, the entire contents of which are incorporated herein by reference.

### RELATED ART

As digital contents have become available to a large extent, the problem of copyright infringements of illegally copying digital contents has become serious. When contents are recorded on recording mediums such as recording tapes as analog data, both audio data and video data are recorded as analog data. The quality of analog data is degraded as the data are copied repeatedly. On the other hand, when audio data and video data are recorded and reproduced by means of recording/reproduction apparatus that operate digitally as digital data, the quality of digital data is essentially not degraded if the data are copied repeatedly.

Thus, the loss that copyright owners suffer due to illegal copying is greater when digital equipment is used than when analog equipment is used for illegal copying. Therefore, it is a serious problem to protect copyrights against illegal copying when digital equipment is involved.

Known popular techniques for preventing illegal copying include those of mutual authentication of equipment and contents. The contents are allowed to be copied according to the copying authorizing information contained in the contents only when the equipment is authenticated.

For example, Patent Document 1 (Japanese Patent Application Laid-Open Publication No. 2000-195159) describes a copyright protection policy of using a copy control system that limits generations of copies, which is referred to as SCMS (serial copy management system), for CDs (compact discs), MDs (mini discs), DATs (digital audio tapes) and so on. More specifically, according to such a system, audio contents are authorized to be copied only once but copying a copy of audio contents is prohibited.

The SCMS will be described in detail below by referring to FIG. 1. Audio signals from an original source are recorded on disc 71 as digital signals. The digital audio signals are recorded in a predetermined recording format on the disc 71 and annex information telling that the audio signals are authorized to be copied only once according to the SCMS is contained in the digital signals and recorded on a specific recording region of the disc 71.

Reproduction apparatus 72 reproduces the digital audio signals it reads out from the disc 71 and transmits them to recording apparatus 73 with the annex information. More specifically, the reproduction apparatus 72 transmits the digital audio signals to the recording apparatus 73 at the normal (proper) reproduction speed. In other words, the time spent for transmitting the digital audio signals is equal to the time that is spent when the listener listens to the contents of the audio signals.

When the annex information of the audio signals tells that the digital audio signals are authorized to be copied once, the recording apparatus 73 that received the digital audio signals as input signals recognizes that the signals can be copied once. After confirming that the annexed information tells that the digital audio signals are authorized to be copied only once, the recording apparatus 73 records the digital audio signals on a recordable disc 74 as copy. At this time, the recording apparatus 73 amends the annex information “authorized to be copied once” so as to read as “copying prohibited”. Thus, the digital audio signals are recorded on the disc 74 as copy along with the annex information “copying prohibited”.

When the disc 74 (first generation disc) to which the digital audio signals are copied for once is replayed by the reproduction apparatus 75 and the digital audio signals are supplied to the recording apparatus 76, the recording apparatus 76 detects that the annex information tells “copying prohibited”. Thus, the recording apparatus 76 can no longer record the digital audio signals to recordable disc 77.

However, with the above-described known copyright protection technique, the equipment and the contents mutually authenticate each other and the contents are permitted to be copied or transferred according to the copying authorizing information annexed to the contents only when the equipment is authenticated. Thus, with a system using the technique, a buyer who bought the contents can only enjoy the contents only within the limitations imposed by the contents.

### DISCLOSURE OF THE INVENTION

### Problems to be Solved by the Invention

In view of the above-identified circumstances, it is therefore the object of the present invention to provide a recording medium, a recording/reproduction apparatus and a replay apparatus that technically make it not only impossible to infringe copyrights but possible for a buyer who properly bought contents to personally freely reproduce and enjoy the contents.

In an aspect of the present invention, the above objects is achieved by providing a recording medium bearing encrypted contents recorded thereon, the medium including: a first recording region bearing the contents encrypted by a contents key and recorded therein; a second recording region bearing a data providing a basis for the contents key and recorded therein; a third recording region allowing the encrypted contents key obtained by encrypting the contents key generated from the data providing a basis for the contents key by means of identification information on a user to be recorded therein.

Thus, the information providing a basis for the contents key is read out from the second recording region and a contents key is generated by carrying out predetermined arithmetic operations on the information providing basis for the contents key. The contents key is encrypted typically by the biometric identification information on the user. The encrypted contents key is then recorded in a predetermined recording region (third recording region).

In another aspect of the present invention, the above object is achieved by providing a recording/reproduction apparatus for writing data on a recording medium bearing encrypted contents data recorded thereon, the apparatus including: a reproduction means for reproducing the data providing a basis for a contents key of the encrypted contents data recorded on the recording medium in advance by the contents key from a second recording region bearing data providing a basis for the contents key; a contents key generation means for generating a contents key from the data providing a basis for a contents key; an acquisition means for acquiring identification information on a user authorized to reproduce the contents corresponding the contents data; an encrypted contents key generation means for generating an encrypted contents key encrypted by means of the generated contents key and the acquired identification information on the user; and a recording means for recording the generated encrypted contents key in a third recording region of the recording medium.

Thus, the reproduction means reproduces the data providing a basis for a contents key from the second recording region and the contents key generation means generates a contents key from the data providing a basis for a contents key. Then, the acquisition means acquires identification information on a user who is authorized to reproduce the contents corresponding to the contents data and the encrypted contents key generation means generates an encrypted contents key encrypted by means of the generated contents key and the acquired identification information on the user. Thereafter, the recording means records the generated encrypted contents key in a third recording region of the recording medium.

In still another aspect of the present invention, the above object is achieved by providing a replay apparatus for replaying a recording medium bearing encrypted contents data recorded thereon, the apparatus including: a first reproduction means for reproducing the encrypted contents data recorded in a first recording region of the recording medium; a second reproduction means for reproducing the encrypted contents key for decrypting the cryptogram of the encrypted contents, the encrypted contents key being recorded in a second recording region of the recording medium; an input means for inputting identification information on a user; an encrypted contents key decryption means for decrypting the contents key by means of the encrypted contents key and the identification information on the user; and a contents data decryption means for decrypting the encrypted contents data reproduced by the first reproduction means by means of the contents key decrypted by the contents key decryption means.

Thus, the first reproduction means reproduces the encrypted contents data recorded in the first recording region of the recording medium and the second reproduction means reproduces the encrypted contents key for decrypting the cryptogram of the encrypted contents, the encrypted contents key being recorded in a third recording region of the recording medium. Then, the input means inputs identification information on a user and the encrypted contents key decryption means decrypts the contents key by means of the encrypted contents key and the identification information on the user. Thereafter, the contents data decryption means decrypts the encrypted contents data reproduced by the first reproduction means by means of the contents key decrypted by the contents key decryption means.

### BRIEF DESCRIPTION OF THE DRAWINGS

FIG. 1 is a schematic block diagram of a copy control system, which is the SCMS;

FIG. 2 is a schematic illustration of the format of an optical disc that is a first specific embodiment of disc-shaped recording medium according to the present invention;

FIG. 3 is a schematic block diagram of an optical disc recording/reproduction apparatus, which is a specific embodiment of recording apparatus according to the present invention, showing the configuration thereof;

FIG. 4 is a schematic block diagram of the recording signal processing section of the optical disc recording/replay apparatus of FIG. 3;

FIG. 5 is a flowchart of the processing sequence of the optical disc recording/reproduction apparatus of FIG. 3;

FIG. 6 is a schematic block diagram of an optical disc replay apparatus, which is a specific embodiment of replay apparatus according to the present invention, showing the configuration thereof;

FIG. 7 is a schematic block diagram of the reproduced signal processing section of the optical disc replay apparatus of FIG. 6;

FIG. 8 is a flowchart of the processing sequence of the optical disc replay apparatus of FIG. 6;

FIG. 9 is a schematic illustration of the reading means for reading information that provides a basis for a contents key in the optical disc recording/reproduction apparatus and the optical disc replay apparatus;

FIG. 10 is a schematic illustration of the format of an optical disc that is a second specific embodiment of disc-shaped recording medium according to the present invention;

FIG. 11 is a schematic block diagram of an optical disc recording/reproduction apparatus for recording encrypted contents on the optical disc of FIG. 10 that is the second specific embodiment;

FIG. 12 is a schematic block diagram of the IC chip on the optical disc of FIG. 10 and that of the read out section for reading the information providing a basis for a contents key in the recording apparatus of FIG. 11, showing the configurations thereof in detail; and

FIG. 13 is a flowchart of the processing sequence of the optical disc recording/reproduction apparatus of FIG. 11.

### BEST MODE FOR CARRYING OUT THE INVENTION

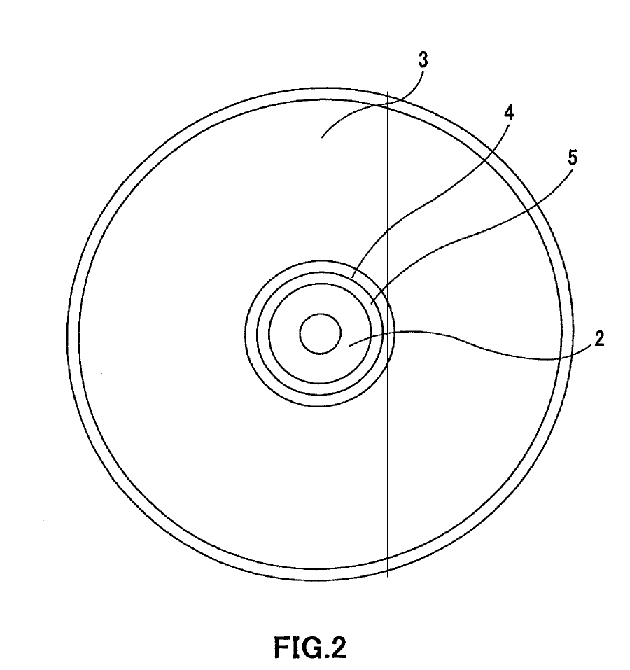

Now, the present invention will be described in greater detail by referring to the accompanying drawings that illustrate the best mode for carrying out the present invention. FIG. 2 is a schematic illustration of the format of an optical disc that is a first specific embodiment of disc-shaped recording medium according to the present invention. For the purpose of the present invention, a disc-shaped recording medium may be an optical disc where data are recorded typically by means of emboss pits and phase change marks or a magneto-optical disc where data are magneto-optically recorded by utilizing the Kerr effect. More specifically, disc-shaped recording mediums include compact discs (CDs), super audio (SA) CDs, digital versatile discs (DVDs), mini discs (NDs) and high density MDs. Additionally, semiconductor recording mediums such as silicon mediums can also be used for the purpose of the present invention.

As shown in FIG. 2, the disc-shaped recording medium 1 has a table of contents (TOC) recording region 2 that is located at the innermost peripheral side and in which management information for the entire recording medium is recorded and a contents recording region (first recording region) 3 in which the contents managed by the TOC recording region 2, which are contents C_{E} encrypted by a contents key in this particular example, are to be recorded. The recording medium additionally has a contents key basic information recording region (second recording region) 5 that is located at the outside of the TOC recording region 2 and in which information S_{kc} that provides basis for a contents key is stored and an encrypted contents key recording region (third recording region) 4 located between the second recording region and the contents recording region and in which a contents key fₑ(U, k_{c}) encrypted by user information U, which will be described in greater detail hereinafter, is to be recorded. Note that the positions of the first recording region 2, the second recording region 5 and the third recording region 4 are not limited to those in the format of FIG. 2. For example, the second recording region 5 may be arranged outside the first recording region 3 and the third recording region 4 may be arranged outside the first recording region 3.

The TOC recording region 2 and the first recording region 3 are pre-mastered regions, whereas the second recording region 5 is a pre-recorded region where information S_{kc} that provides a basis for a contents key is pre-recorded at the time of shipment from the plant.

The encrypted contents C_{E} that are to be recorded in the first recording region 3 include audio information and/or video information. In other words, the encrypted contents C_{E} are music, images or images accompanied by music. Of course, the encrypted contents C_{E} may be movie contents. The contents data are digital data and hence the quality thereof is hardly degraded if they are copied. Therefore, if the digital contents are copied freely without restrictions and reproduced, the copyright of the author of the contents can be unduly infringed. Thus, the contents data are encrypted by a contents key in order to restrict reproduction and copying of the digital contents.

The information S_{kc} recorded in the second recording region 5 to provide a basis for a contents key is key information for generating a contents key. The information S_{kc} is already recorded in the second recording region 5 before the disc-shaped recording medium 1 is replayed by a replay apparatus according to an user operation. More often than not, the information S_{kc} is recorded before or at the time when the user purchases the recording medium and hence the time of recording the information S_{kc} is not limited to the time of shipment from the plant.

For example, the information S_{kc} may be recorded at the time of manufacturing the disc-shaped recording medium 1, at the time of shipment or at the time when the user purchase the disc-shaped recording medium 1 at a retail shop. In any case, the information S_{kc} is recorded instantaneously at the time or immediately before or after the time when the encrypted contents C_{E} are recorded in the first recording region 3. A contents key k_{c} is obtained according to the information S_{kc} that provides a basis for the contents key. In other words, the information S_{kc} is expressed by a function f_{kc} for contents key k_{c}, or f_{kc}(k_{c})=S_{kc}. The contents key k_{c} is an encryption key to be used when generating encrypted contents C_{E} to be recorded in the first recording region 3.

The second recording region 5 is a write once type recordable region, where information that provides a basis for a contents key is recorded. Its recording format is same as the recording format of a so-called-R type optical disc. The second recording region 5 may be a region where data can be erased. For example, the data recorded in the second recording region 5 may be erased by irradiating a laser beam from the recording/reproduction head 10 at a predetermined power level and writing a same predetermined data (e.g., &HFF or &H00) repeatedly on the data already recorded there to blot out the latter.

The encrypted contents key fₑ(U, k_{c})=k_{c}′ to be recorded in the third recording region 4 is picked up when the user performed a registration operation at a recording/reproduction apparatus for the first time. For example, it is an encrypted key obtained by encrypting the contents key k_{c} by means of user information U that is biometric identification information such as a fingerprint, a voice print or an iris.

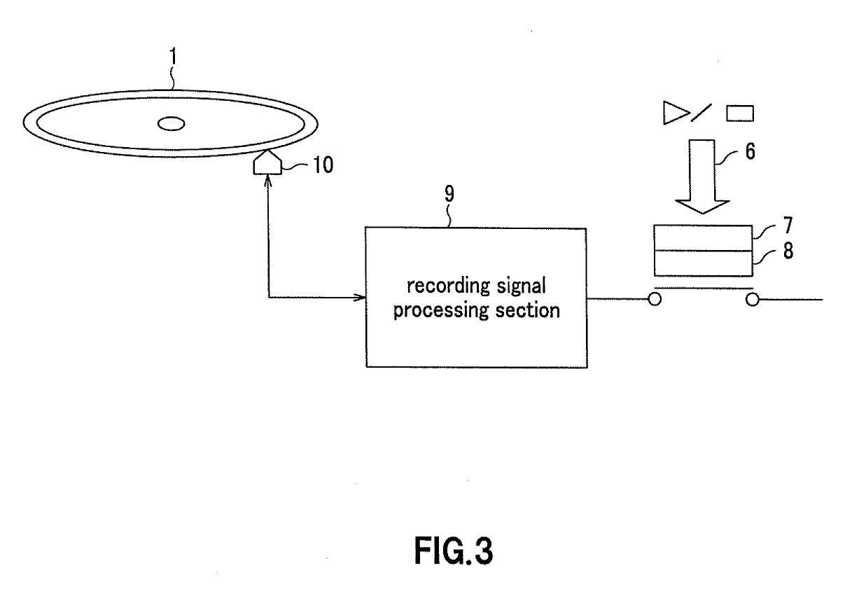

FIG. 3 is a schematic block diagram of an optical disc recording/reproduction apparatus for recording an encrypted contents key fₑ(U, k_{c})=k_{c}′ in the third recording region 4 of the above-described disc-shaped recording medium 1, showing the configuration thereof. It may also be referred to as encrypted contents key write apparatus. The disc recording/reproduction apparatus writes data (encrypted contents key) on a disc-shaped recording medium where encrypted contents data are recorded.

The disc recording/reproduction apparatus comprises a replay button 8 for a proper user of the disc-shaped recording medium 1 to perform a replay operation, an identification information acquisition section 7 arranged on the replay button 8 to acquire the biometric identification information of the user, a recording signal processing section 9 for executing a process for recording the encrypted contents key k_{c}′ in the third recording region of the disc-shaped recording medium 1 and a recording/reproduction head 10 for recording the encrypted contents key k_{c}′ on and reproducing information necessary for recording the encrypted contents key k_{c}′ from the disc-shaped recording medium 1. Particularly, as will be described in greater detail hereinafter, the recording signal processing section 9 has a contents key generation section for generating a contents key from the data that provides a basis for contents key and an encrypted contents key generation section for generating an encrypted contents key by means of the generated contents key and acquired identification information on the user.

Now, the operation of the disc recording/reproduction apparatus when the user accesses a purchased disc-shaped recording medium 1 for the first time will be described. This operation is the recording/reproduction process of the encrypted contents key k_{c}′. Firstly, the user mounts the disc-shaped recording medium 1 on the turntable of the recording/reproduction apparatus.

The recording/reproduction head 10 reads out the information S_{kc} that provides a basis for the contents key from the second recording region 5 of the disc-shaped recording medium 1 and transmits it to the recording signal processing section 9.

Then, the user depresses the reproduction button 8 for a reproduction operation 6. Then, the identification information acquisition section 7 arranged on the reproduction button 8 reads out the identification information of the user, which may be biometric identification information. The user's identification information U read out by the identification information acquisition section 7 is then sent to the recording signal processing section 9.

Then, the recording signal processing section 9 generates a contents key k_{c} from the information S_{kc} that provides a basis for the contents key. Subsequently, the information S_{kc} that provides a basis for the contents key is erased. Additionally, the recording signal processing section 9 generates an encrypted contents key k_{c}′, using the user's identification information U for the generated contents key k_{c}′.

Then, the recording signal processing section 9 writes the encrypted contents key k_{c}′ in the third recording region 4 of the disc-shaped recording medium 1. The process of writing an encrypted contents key on the disc-shaped recording medium 1 proceeds in the manner as summarily described above.

The encrypted contents key k_{c}′ written in the third recording region 4 is read out later when the encrypted contents C_{E} are reproduced by a disc replay apparatus, which will be described in greater detail hereinafter. Then, the encrypted contents key k_{c} is decrypted by the identification information U acquired by the identification information acquisition section to produce the contents key k_{c}. The encrypted contents C_{E} are then decrypted by the produced contents key k_{c} and the contents are reproduced. The operation of contents reproduction by the replay apparatus will be described in greater detail hereinafter.

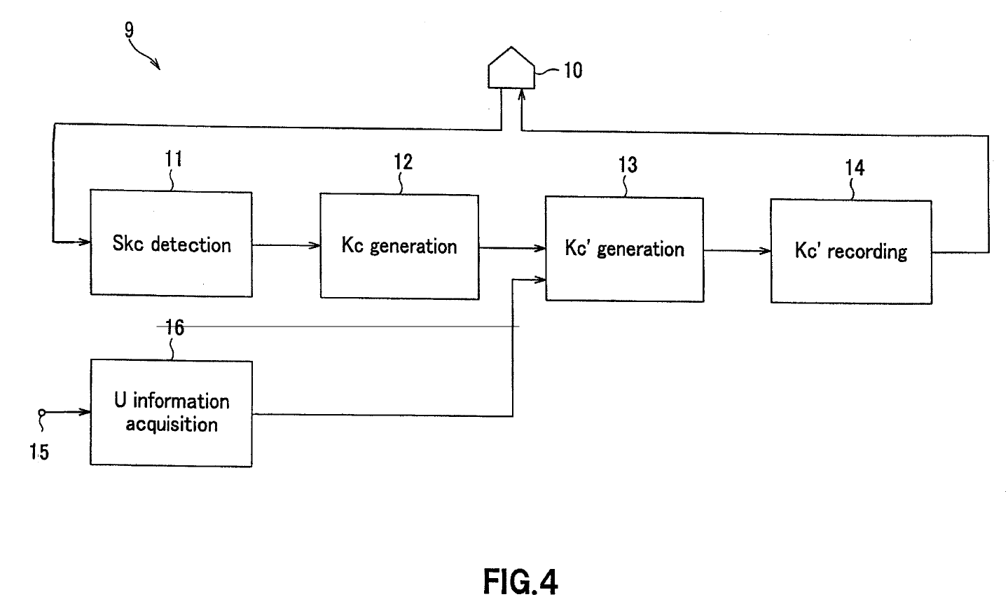

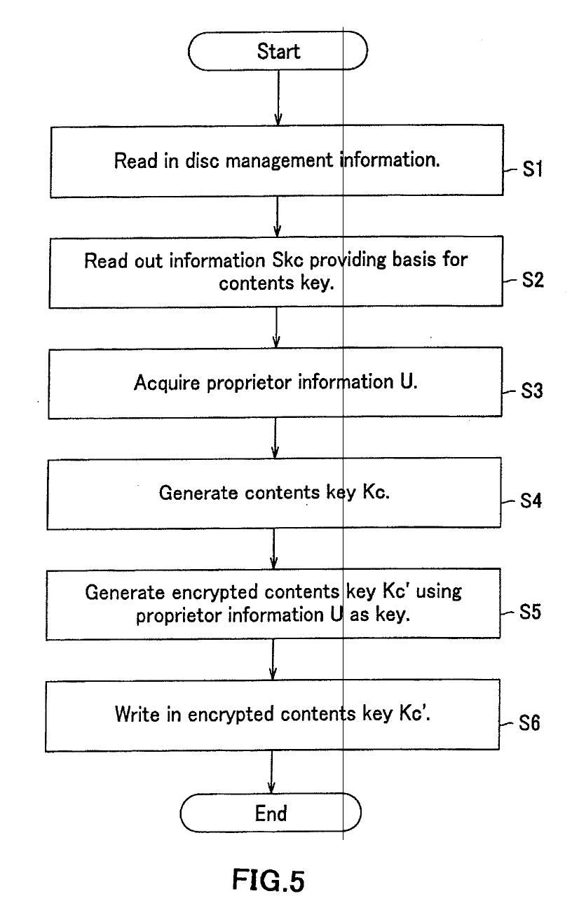

FIG. 4 is a schematic block diagram of the recording signal processing section 9. FIG. 5 is a flowchart of the processing sequence of the recording signal processing section 9.

Firstly, as shown in Step S1 of FIG. 5, the disc recording/reproduction apparatus reads out the disc management information (TOC) from the TOC recording region 2 by means of the recording/reproduction head 10. The addresses to be accessed for the first, second and third recording regions 3, 5 and 4 of the optical disc become known from the TOC.

In Step S2, the position of the second recording region 5 is identified from the address that becomes known from the TOC and the information S_{kc} that provides a basis for the contents key is read out from the identified position of the second recording region 5.

Thereafter, in Step S3, the user's identification information read out by the identification information acquisition section 7 arranged on the reproduction button 8 is supplied to the user information acquisition section 16 by way of the input terminal 15 and acquired by the user information acquisition section 16.

Then, in Step S4, the contents key k_{c} generation section 12 generates a contents key k_{c} from the information S_{kc} that provides a basis for the contents key. As pointed out above, the information S_{kc} that provides a basis for the contents key is generated as function f_{kc}(k_{c})=S_{kc} and the disc recording/reproduction apparatus already holds the function f_{kc}. If the disc recording/reproduction apparatus is manufactured by the manufacturer of the disc-shaped recording medium, the apparatus holds the function f_{kc} because it is recorded in the memory section of the apparatus as information corresponding to the disc type. It is also possible for the disc recording/reproduction apparatus to hold the function f_{kc} from the web site of the manufacturer of the disc-shaped recording medium on the Internet in a secured condition. Thus, the k_{c} generation section 12 of the recording signal processing section 9 can generate a contents key k_{c} from f_{kc}⁻¹(S_{kc}), using the inverse function f_{kc}⁻¹ of the above-described function f_{kc}. Thereafter, the information S_{kc} that provides a basis for the contents key is erased.

In the next step, or Step S5, the encrypted contents key k_{c}′ generation section 13 generates an encrypted contents key k_{c}′, using the user identification information (user information) U. More specifically, the encrypted contents key k_{c}′ generation section 13 computes fₑ(U, k_{c}) to generate an encrypted contents key k_{c}′. In other words, it makes fₑ(U, k_{c})=k_{c}′ hold true.

In the nest step, or Step S6, the encrypted contents key k_{c}′ recording section 14 writes the encrypted contents key k_{c}′ in the third recording region 4 at the address that is already known from the process of reading out the TOC in Step S1. As a result, the encrypted contents key k_{c}′ that is encrypted by means of the user's identification information (user information) is written on the disc-shaped recording medium 1.

As described above, the disc recording/reproduction apparatus does not directly record the contents key k_{c} on the disc-shaped recording medium 1. In other words, the disc-shaped recording medium 1 records only the encrypted contents key k_{c}′ that is encrypted by means of the user information U. The information S_{kc} that provides a basis for the contents key is already recorded on the disc-shaped recording medium 1 as pre-recorded information (at the time of shipment from the plant or at the time or immediately before or after the time when the user bought the disc-shaped recording medium 1). However, it is impossible to generate the contents key k_{c} by using the information S_{kc} that provides a basis for the contents key and the encrypted contents key k_{c}′ directly in the disc replay apparatus unless the user's identification information U is not used. Thus, it is possible to perfectly nullify any fraudulent attempt of a malicious third party.

Additionally, as shown in FIG. 5, the disc recording/reproduction apparatus generates a contents key k_{c} in Step S4 after acquiring the user information (biometric identification information) U in Step S3. Therefore, if the person replaying the disc-shaped recording medium 1 is on the black list and requires special attention, the fact will be grasped before generating a contents key k_{c}. For example, a person who is on the black list will be prevented from proceeding to the next step. In this way, the risk of illegal copying will be reduced.

As pointed out above, the second recording region 5 of the above-described specific example is a write once type recordable region, where information that provides a basis for a contents key is recorded. Its recording format is same as the recording format of a so-called-R type optical disc.

The second recording region 5 may be a region where data can be erased. For example, the data recorded in the second recording region 5 may be erased by irradiating a laser beam from the recording/reproduction head 10 at a predetermined power level and writing a same predetermined data such as “1” of “0” repeatedly on the data already recorded there to blot out the latter. When the second recording region 5 is a region where data can be erased, it is possible to erase the information S_{kc} that provides a basis for a contents key completely from the disc-shaped recording medium. Then, it is possible to safely protect the contents on the disc-shaped recording medium.

Now, the disc replay apparatus for replaying the disc-shaped recording medium 1 where the encrypted contents key k_{c}′ is recorded in the third recording region 4 by the disc recording/reproduction apparatus will be described below. The disc replay apparatus generates a contents key k_{c} from the encrypted contents key k_{c}′ by using the user information U and decrypts the encrypted contents C_{E} by means of the contents key k_{c} to reproduce the contents.

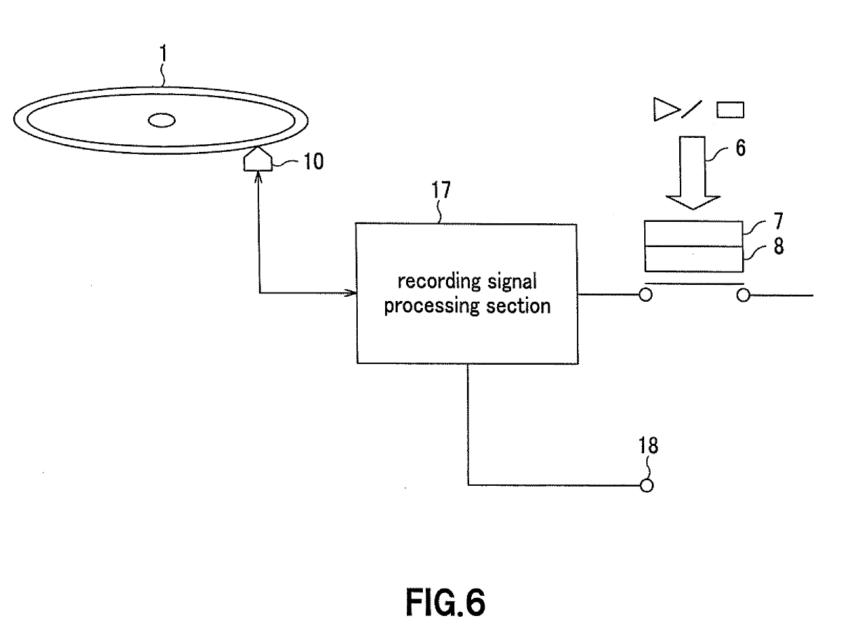

Referring to FIG. 6, the disc replay apparatus comprises an identification information acquisition section 7 for acquiring personal identification information such as biometric identification information of the user/operator when the user accesses the disc-shaped recording medium 1 for the first time and a reproduced signal processing section 17 for generating a contents key k_{c} from the encrypted contents key k_{c}′ by means of the personal identification information U acquired by the identification information acquisition section 7, decrypting the encrypted contents C_{E} by means of the contents key k_{c} and leading out the contents to the outside from the output terminal 18. Note that the identification information acquisition section 7 is arranged on the replay button 8.

The disc replay apparatus will be described in greater detail below. The disc replay apparatus further comprises a first reproduction section (recording/reproduction head 10) for reproducing the contents data encrypted and recorded in the first recording region 3 of the disc-shaped recording medium 1, a second reproduction section (recording/reproduction head 10) for reproducing the encrypted contents key for decrypting the encrypted contents recorded in the third recording region 4 of the recording medium, an input section (identification information acquisition section 16) for inputting recognition information on user, an encrypted contents key decryption section (contents key k_{c} generation section 22) for decrypting the contents key by means of the encrypted contents key and the identification information on the user and a contents data decryption section (contents decryption section 24) for decrypting the encrypted contents data reproduced by the first reproduction section by means of the contents key decrypted by the contents key decryption section.

Now, the operation of the disc replay apparatus for replaying the disc-shaped recording medium 1 where the encrypted contents key fₑ(U, k_{c}) is already recorded in the third recording region 4 will be described below.

Firstly, the user puts the disc-shaped recording medium 1 on the turntable of the disc replay apparatus. Then, the recording/reproduction head 10 reads out the data recorded in the third recording region 4 of the disc-shaped recording medium 1. The reproduced signal processing section 17 detects the encrypted contents key k_{c}′ from the recording/reproduction head 10. Then, the reproduced signal processing section 17 generates a contents key k_{c} from the encrypted contents key k_{c}′, using the personal identification information U.

Thereafter, the reproduced signal processing section 17 decrypts the encrypted contents C_{E} that are recorded in the first recording region 2 by means of the contents key k_{c} and leads them to the outside.

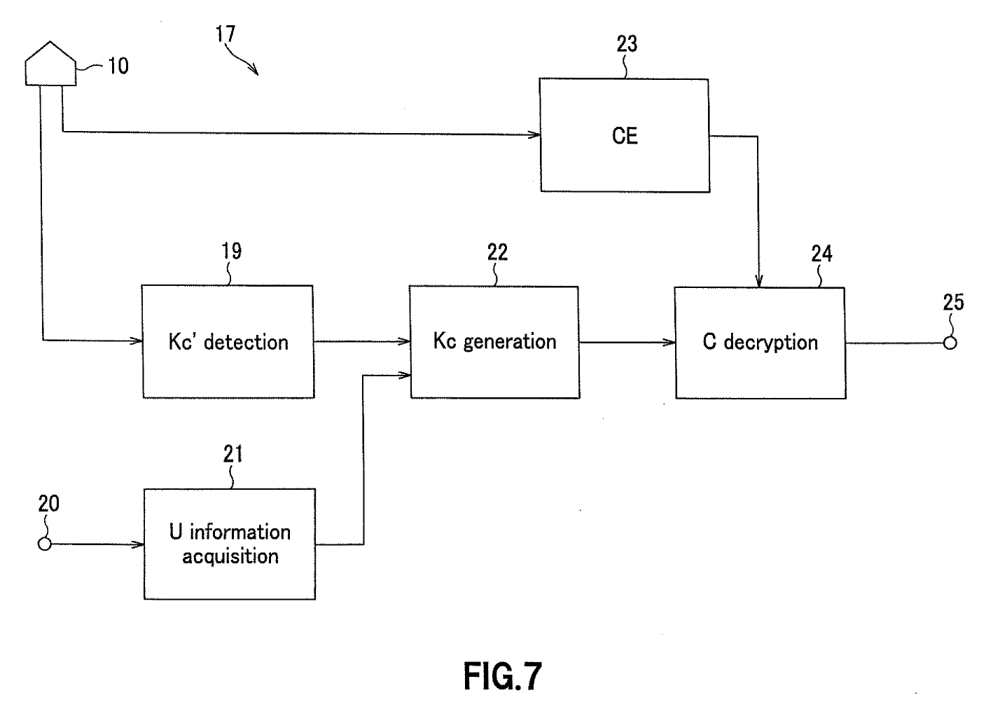

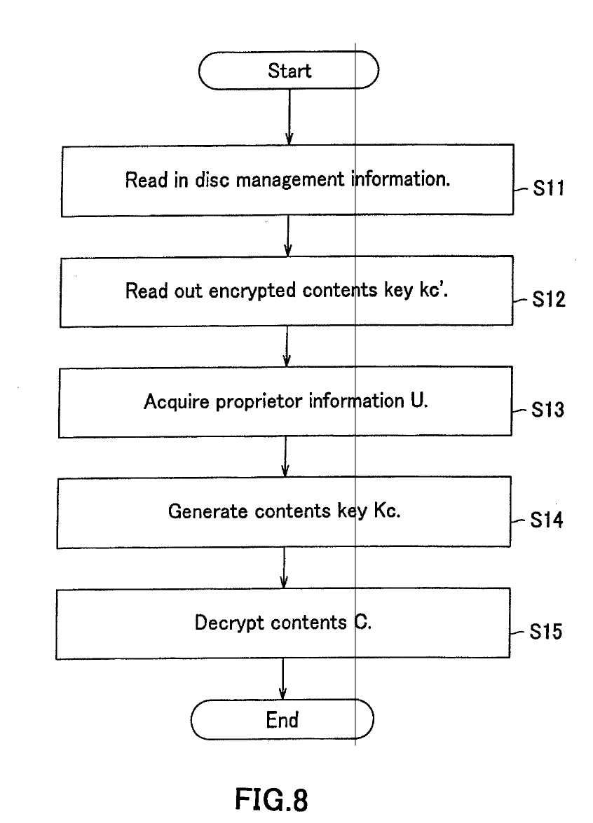

Now, the operation of the disc replay apparatus will be described in greater detail by referring to FIGS. 7 and 8. FIG. 7 is a schematic block diagram of the reproduced signal processing section 17. FIG. 8 is a flowchart of the processing sequence of the reproduced signal processing section 17.

Firstly, as shown in Step S11 of FIG. 8, the disc replay apparatus reads out the TOC from the TOC recording region 2 by means of the recording/reproduction head 10. The addresses to be accessed for the first, second and third recording regions 3, 5 and 4 of the optical disc become known from the TOC.

In Step S12, the position of the third recording region 4 is identified from the address that becomes known from the TOC and the contents key k_{c}′ detecting section 19 reads out the encrypted contents key k_{c}′ from the data that are read out by the recording/reproduction head (second reproduction section) 10 from the identified position of the third recording region 4.

Then, in Step S13, the user's identification information read out by the identification information acquisition section 7 arranged on the replay button 8 is supplied to and acquired by the user information acquisition section 21 by way of the input terminal 20.

Thereafter, in Step S14, the contents key k_{c} generation section (encrypted contents key decryption section) 22 generates a contents key k_{c}. More specifically, the contents key k_{c} generation section 22 computes fₑ⁻¹(U, k_{c}′), using the encrypted contents key k_{c}′ detected by the encrypted contents key k_{c}′ detecting section 19 in Step S12 and the identification information U acquired by the user information acquisition section 21 in Step S13, to generate a contents key k_{c}. In other words, the contents key k_{c} generation section 22 solves the equation fₑ⁻¹(U, k_{c}′)=k_{c}. Note that fₑ⁻¹ is the inverse function of the function fₑ that is used when generating the encrypted contents key k_{c}′ from U and k_{c} and the disc replay apparatus holds the inverse function fₑ⁻¹.

Then, in Step S15, the contents decryption section 24 decrypts the encrypted contents 23 that are already read out by the recording/reproduction head (first reproduction section) 10 and temporarily stored in a memory, for example, by means of the contents key k_{c} and leads them out to the outside by way of the output terminal 25.

As pointed out above the contents key k_{c} is not recorded straight on the disc-shaped recording medium 1 but an encrypted contents key k_{c}′ that is encrypted by means of the user's identification information U is recorded in the third recording region 4. In other words, it is impossible to obtain the contents key k_{c} unless acquiring the user's identification information U. Thus, it is not possible to generate a contents key k_{c} unless acquiring the proper user's identification information U.

The user's identification information U is not written on the disc but becomes known only when the user uses the disc. Regardless of the recording region of the disc-shaped recording medium 1 where the encrypted contents key k_{c}′ is stored, the user is required to operate the identification information acquisition section 7 for finger print authentication, for example, in order to acquire the contents key k_{c} from the encrypted contents key k_{c}′.

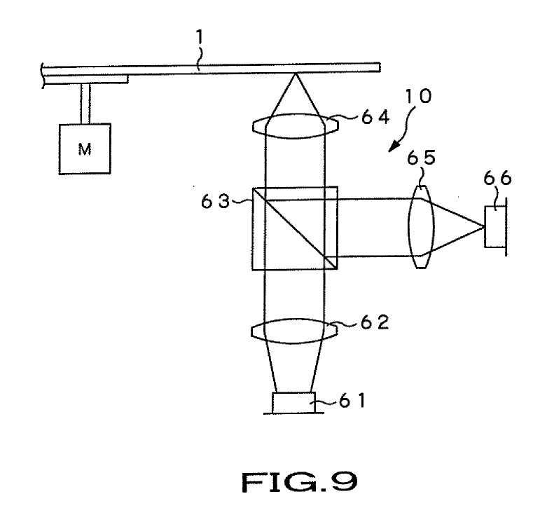

FIG. 9 is a schematic illustration of an exemplary recording/reproduction head 10. Referring to FIG. 9, the laser beam emitted from a laser beam source 61 is collimated by a collimator lens 62, transmitted through a beam splitter 63 and converged by an objective lens 64 before it is irradiated onto the disc-shaped recording medium 1.

The TOC recording region 1 through the third recording region 4 are formed on the disc-shaped recording medium 1 as shown in FIG. 2. If necessary, the recording/reproduction head 10 moves the beam spot to the desired recording region, while reading the TOC in the TOC recording region 2.

The returning beam reflected from the disc-shaped recording medium 1 is transmitted through the objective lens 64, reflected by the beam splitter and condensed by the condenser lens 65 before it is received by the photo-detector 66. The photo-detector 66 generates an electric signal according to the quantity of light it receives and transmits it to the reproduced signal processing section or the recording signal processing section.

In this way, the recording/reproduction head 10 reads out the information S_{kc} that provides a basis for a contents key typically from the second recording region 5. It also writes the encrypted contents key k_{c}′ in the third recording region 4 and reads out the encrypted contents C_{E} from the second recording region 3.

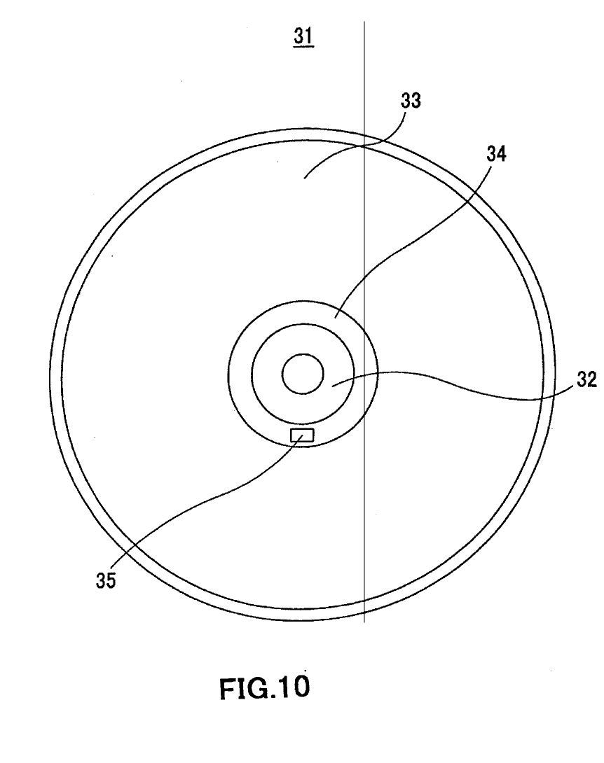

Now, the second specific embodiment of recording medium according to the present invention will be described below by referring to FIG. 10. FIG. 10 is a schematic illustration of the format of the second embodiment of recording medium of the present invention that is a disc-shaped recording medium 31. Like the first specific embodiment, this disc-shaped recording medium 31 may be an optical disc or a magneto-optical disc.

Referring to FIG. 10, the disc-shaped recording medium 31 has a TOC recording region 32 that is located at the innermost peripheral side and a contents recording region (first recording region) 33 in which the encrypted contents C_{E} managed by the TOC recording region 2 are to be recorded. The recording medium 31 additionally has a contents key basic information recording IC (contents key basic information recording IC) 35 that is located at the outside of the TOC recording region 32 and in which information S_{kc} that provides basis for a contents key is stored and an encrypted contents key recording region (third recording region) 34 that has part of the contents key basic information recording IC 35 and in which a contents key fₑ(U, k_{c}) encrypted by user information U, which will be described in greater detail hereinafter, is to be recorded.

The TOC recording region 32 and the first recording region 33 are pre-mastered regions, whereas the second recording region 35 is a pre-recorded region where information S_{kc} that provides a basis for a contents key is pre-recorded. More specifically, the second recording region is an integrated circuit IC 35.

The configurations of the TOC recording region 32, the first recording region 33 and the third recording region 34 are same as those of the disc-shaped recording medium 1 of the first specific embodiment shown in FIG. 2 and hence will not be described any further below. Only the second recording region 35 differs from the first embodiment.

The third recording region 35, which is an integrated circuit (IC), stores information S_{kc} that provides a basis for a contents key. As pointed out above, the information S_{kc} that provides a basis for a contents key is recorded before the disc-shaped recording medium 31 is handed to the user.

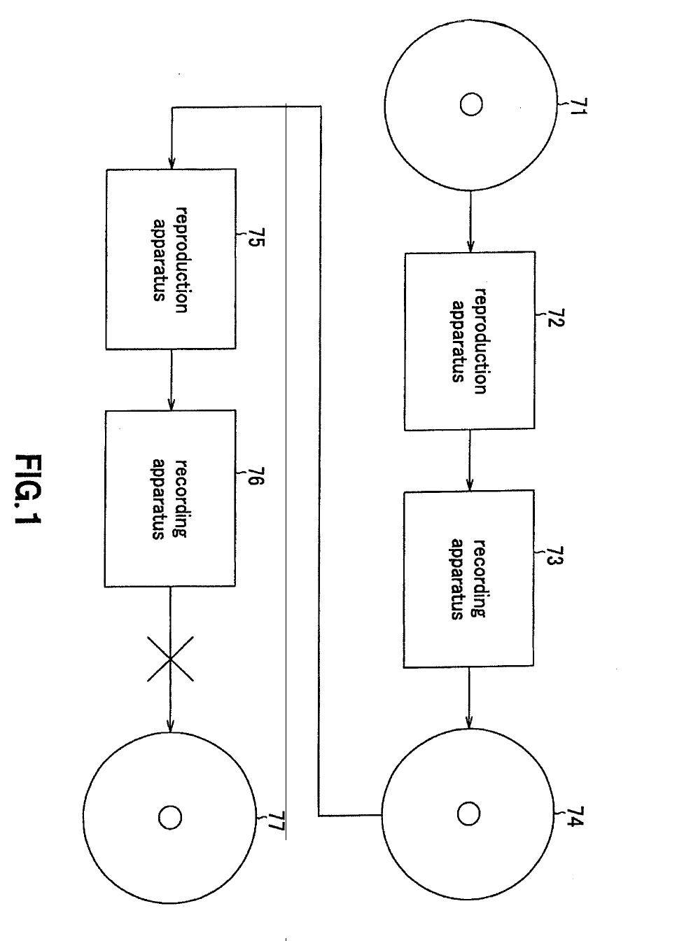

FIG. 1 is a schematic block diagram of a disc recording/replay apparatus for recording encrypted contents key on the disc-shaped recording medium 31. The disc recording/reproduction apparatus comprises a replay button 8 for a proper user of the disc-shaped recording medium 1 to perform a replay operation, an identification information acquisition section 7 arranged on the replay button 8 to acquire the biometric identification information of the user, a recording signal processing section 9 for executing a process for recording the encrypted contents key in the third recording region of the disc-shaped recording medium 1 and a recording/reproduction head 10 for recording the encrypted contents key on and reproducing information necessary for recording the encrypted contents key from the disc-shaped recording medium 1. Additionally, the disc-shaped recording medium 31 has an IC information read section 37 for reading out the information that provides a basis for the contents key from the IC section 35. The IC information read section 37 is a so-called IC reader that can read the information stored in the IC, approaching the non-contact type IC 35 and communicating with the IC 35.

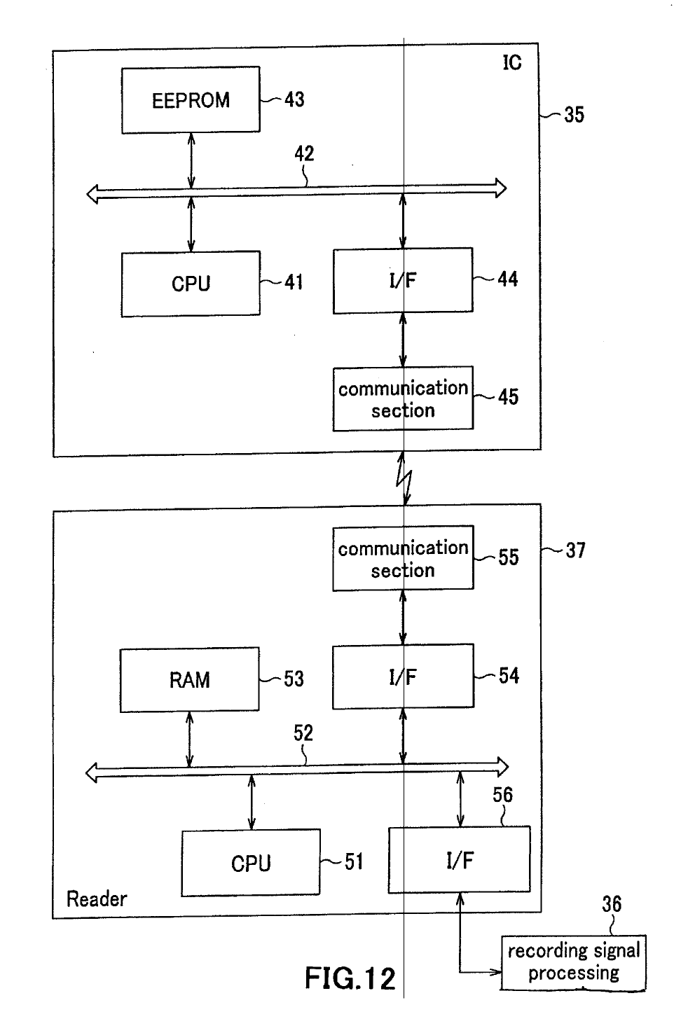

As shown in FIG. 12, the IC 35 is connected to an EEPROM (electrically erasable programmable read only memory) 43 that is a non-volatile memory and adapted to change the recorded signals and an interface 44 by way of a CPU bus 42. The interface 44 is connected to a radio communication section 45.

Also as shown in FIG. 12, in the IC information read section 37 that is an IC reader, a RAM 53 and an IC-side interface 54 are connected to a CPU 51 by way of a CPU bus 52. Additionally, an interface 56 for the side of recording signal processing section 36 is connected to the CPU 51. The IC-side interface 54 is connected to a radio communication section 55.

The IC 35 stores information S_{kc} that provides a basis for a contents key in the EEPROM 43. The IC information read section 37 reads out the information S_{kc} that provides a basis for a contents key from the EEPROM 43 in the IC 35 by radio communications between the radio communication section 55 and the radio communication section 45 under the control of the CPU 51 and supplies the information S_{kc} to the recording signal processing section 36 by way of the I/F 56.

The configuration of the recording signal processing section 36 is substantially similar to the one illustrated in FIG. 4 but differs from the latter in that the information that provides a basis for a contents key is supplied from the IC information read section 37.

The IC 35 that is the second recording region may be so arranged that the information S_{kc} that provides a basis for a contents key is erased or destroyed after it is read out once.

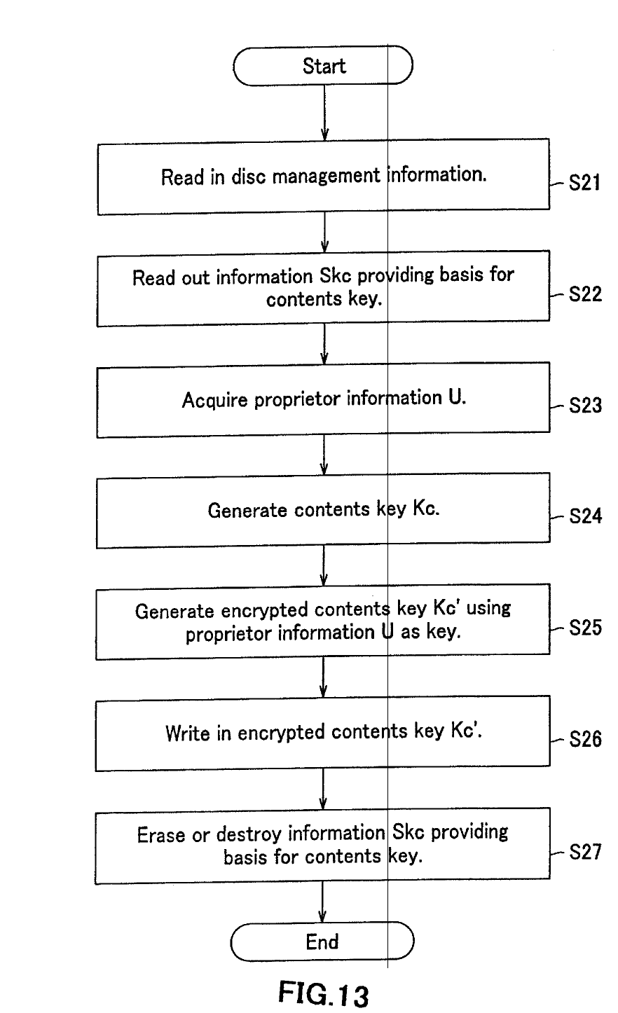

FIG. 13 is a flowchart of the processing sequence of the optical disc recording/reproduction apparatus for the disc-shaped recording medium 31 of FIG. 10 that stores the information S_{kc} that provides a basis for a contents key in the IC 35 in advance.

Referring to FIG. 13, firstly in Step S21, the disc recording/reproduction apparatus reads out the disc management information (TOC) form the TOC recording region 32 by means of the recording/reproduction head 10. The addresses to be accessed for the recording regions 32, 33 and 34 of the optical disc become known from the TOC.

In the next step, or Step S22, the information S_{kc} that provides a basis for the contents key is read out from the IC 35 by means of the IC information read section 37.

Thereafter, in Step S23, the user's identification information U read out by the identification information acquisition section 7 arranged on the reproduction button 8 is supplied to the user information acquisition section 16 by way of the input terminal 15 and acquired by the user information acquisition section 16.

Then, in Step S24, the contents key k_{c} generation section 12 generates a contents key k_{c} from the information S_{kc} that provides a basis for the contents key. As pointed out above, the information S_{kc} that provides a basis for the contents key is generated as function f_{kc}(k_{c})=S_{kc} and the disc recording/reproduction apparatus already knows the function f_{kc}. Thus, the k_{c} generation section 12 of the recording signal processing section 36 can generate a contents key k_{c} from f_{kc}⁻¹(S_{kc}), using the inverse function f_{kc}⁻¹ of the above-described function f_{kc}.

In the next step, or Step S25, the contents key k_{c}′ generation section 13 generates an encrypted contents key k_{c}′, using the user identification information (user information) U. More specifically, the encrypted contents key k_{c}′ generation section 13 computes fₑ(U, k_{c}) to generate an encrypted contents key k_{c}′ in other words, it makes fₑ(U, k_{c})=k_{c}′ hold true.

In the nest step, or Step S26, the encrypted contents key k_{c}′ recording section 14 writes the encrypted contents key k_{c}′ in the third recording region 34 at the address that is already known from the process of reading out the TOC in Step S21. As a result, the encrypted contents key k_{c}′ that is encrypted by means of the user's identification information (user information) is written on the disc-shaped recording medium 31.

Then, in Step S27, the information S_{kc} that provides a basis for a contents key stored in the IC 35 is destroyed typically by means of the IC read section 37. For example, after the information S_{kc} that provides a basis for a contents key stored in the IC 35 is read out for once, the data in the IC 35 can be deleted by sending a predetermined instruction for erasing data to the IC 35 by means of a communication technique such as RF-ID and executing the predetermined instruction.

As described above, the information S_{kc} that provides a basis for a contents key can be protected by destroying or erasing it from the IC 35 in Step S27.

As described above, the disc recording/reproduction apparatus does not directly record the contents key k_{c} on the disc-shaped recording medium 1 either. In other words, the disc recording/reproduction apparatus records only the encrypted contents key k_{c}′ that is encrypted by means of the user information U in the disc-shaped recording medium 31. The information S_{kc} that provides a basis for the contents key is already recorded in the IC 35 as pre-recorded information. However, it is impossible to generate the contents key k_{c} by using the information S_{kc} that provides a basis for the contents key and the encrypted contents key k_{c}′ directly in the disc recording/reproduction apparatus unless the user's identification information is not used. Thus, it is possible to perfectly nullify any fraudulent attempt of a malicious third party.

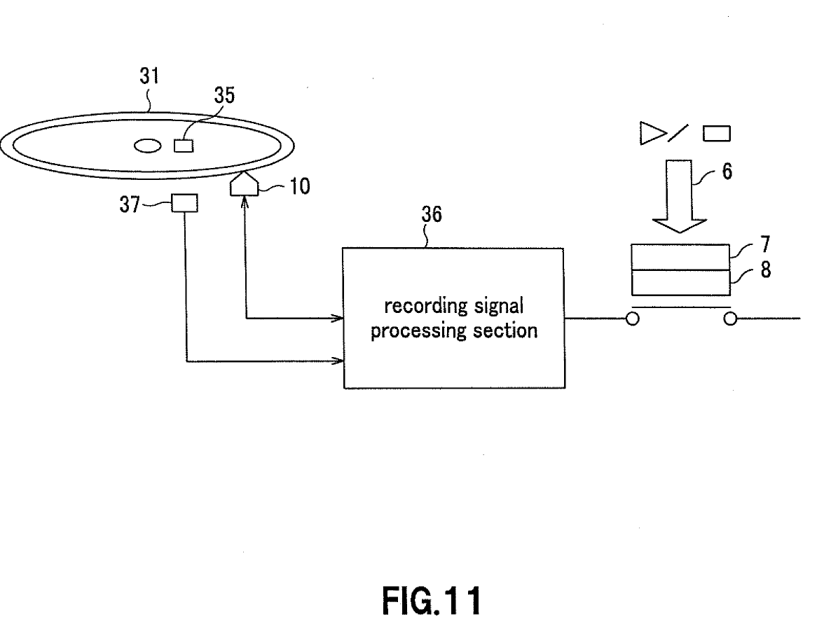

The two disc recording/reproduction apparatus having the respective configurations as shown in FIGS. 3 and 11 can copy what is recorded on the disc-shaped recording mediums 1 and 31 where the encrypted contents keys k_{c}′ that are encrypted by means of the user information U are recorded in the third recording regions 4 and 34 on some other disc-shaped recording medium. If such is the case, it is only necessary to copy the encrypted contents C_{E} in the first recording regions 3 and 33 and the encrypted contents keys k_{c}′ in the third recording regions 4 and 34. In other words, it is not necessary to copy the information S_{kc} that provides a basis for a contents key.

When a copy disc is to be replayed by a disc replay apparatus, the user puts the copy disc in the apparatus and decrypts the encrypted contents key k_{c}′ by means of the biometric identification information U of the operator/user to generate a contents key k_{c}. Then, the user reproduces the contents by decrypting the encrypted contents C_{E} by means of the contents key k_{c}.

Thus, the proper user of the disc-shaped recording medium 1 or 31 can prepare as many copy discs as he or she wants. However, if an unauthorized person tries to copy what is recorded on the disc, identification information that is different from the biometric identification information U that is used when generating the encrypted contents key k_{c}′ is acquired by the replay apparatus for replaying the copy disc so that it is not possible to generate a contents key k_{c} from the encrypted contents key k_{c}′. Then, it is not possible to decrypt the encrypted contents C_{E} when a contents key cannot be generated.

When the proper user of the disc-shaped recording medium where the encrypted contents key is recorded wants to give or sell the disc or a copy disc to some other person, he or she simply has to write a new encrypted contents key in the third recording region 4 or 34 to erase the old encrypted contents key. It may be needless to say that the new encrypted contents key is encrypted by means of the biometric identification information U of the new user to whom the disc is given or sold.

Recording/reproduction apparatus according to the invention include those obtained by modifying the apparatus illustrated in FIGS. 3 and 11 and adapted to record encrypted contents key for each authorized user on a disc-shaped recording medium 1 or 31 that describes the maximum number of persons who can be authorized to use the disc-shaped recording medium.

More specifically, a disc-shaped recording medium that the modified recording/reproduction apparatus can use describes the maximum number of persons who can be authorized to use the recording medium and can record as many pieces of personal identification information as the maximum number and so many encrypted contents keys.

The processing sequences of the modified optical disc recording/reproduction apparatus will be described below by referring to FIGS. 5 and 13. Firstly, the optical disc recording/reproduction apparatus adapted to record the encrypted contents keys of as many users as the maximum number who are authorized to use a disc-shaped recording medium 1 that describes the maximum number of persons who can be authorized to use the recording medium will be described by referring to FIGS. 3 through 5. Information on the maximum number of persons who can be authorized to use the disc-shaped recording medium 1 is written in the TOC region 2 of the recording medium 1.

Referring to FIG. 5, the optical disc recording/reproduction apparatus reads out the disc management information from the TOC recording region 2 by means of its recording/reproduction head 10 in Step S1. The addresses to be accessed for the first, second and third recording regions 3, 5 and 4 of the optical disc become known from the disc management information. The TOC recording region 2 also describes the maximum number of persons who can be authorized to use the recording medium 1. In other words, the optical disc recording/reproduction apparatus can specify the maximum number of persons who can be authorized to use the recording medium 1.

If the number of users who use the recording/reproduction apparatus does not exceed the maximum number, it identifies the position of the second recording region 5 from the address known from the TOC and reads out the information S_{kc} that provides a basis for a contents key from the identified position of the second recording region 5 in Step S2.

In the next step, or Step S3, the user's identification information read out by the identification information acquisition section 7 arranged on the replay button 8 is supplied to and acquired by the user information acquisition section 16 by way of the input terminal 15.

Then, in Step S4, the contents key k_{c} generation section 12 generates a contents key k_{c} according to the information S_{kc} that provides a basis for a contents key. More specifically, the contents key k_{c} generation section 12 of the recording signal processing section 9 can generate a contents key k_{c} from f_{kc}⁻¹(S_{kc}), using the inverse function f_{kc}⁻¹ of the above-described function f_{kc}.

In the next step, or Step S5, the encrypted contents key k_{c}′ generation section 13 generates an encrypted contents key k_{c}′, using the user information U. In the nest step, or Step S6, the encrypted contents key k_{c}′ recording section 14 writes the encrypted contents key k_{c}′ in the third recording region 4 at the address that is already known from the process of reading out the TOC in Step S1. As a result, the encrypted contents key k_{c}′ that is encrypted by means of the user's identification information (user information) is written on the disc-shaped recording medium 1.

Then, the disc recording/reproduction apparatus returns to Step S1 and, if the number of users authorized to operate the apparatus does not exceed the above-described maximum number, it repeats the Steps S2 through S6.

If it is determined that the number of users exceeds the above-described maximum number in Step S1, the disc recording/reproduction apparatus records the encrypted contents key k_{c}′ in the fourth recording region 4 and then erase the above-described information S_{kc} that provides a basis for a contents key from the second recording region 5 of the disc-shaped recording medium 1 in the next step. The second recording region 5 is a region where data can be erased. For example, the data recorded in the second recording region 5 may be erased by irradiating a laser beam from the recording/reproduction head 10 at a predetermined power level and writing a same predetermined data repeatedly on the data already recorded there to blot out the latter.

Thus, with the optical disc recording/reproduction apparatus, it is not possible to read out, from the disc-shaped recording medium 1, the information S_{kc} that provides a basis for a contents key when the number of users exceeds the number of persons who can be authorized to use it. Therefore, if the recording/reproduction apparatus can authorize a plurality of users to use the disc-shaped recording medium 1, the information that provides a basis for contents key is protected.

The information on the number of persons who can be authorized to use the disc-shaped recording medium 1 may be encrypted and recorded in the second recording region 5. In any case, it is possible to record a plurality of encrypted contents key that are encrypted by means of personal identification information of so many persons and so many contents keys in the disc-shaped recording medium 1 as shown in FIG. 2. However, once the number of users exceeds the above-described number of persons who can be authorized to use the disc-shaped recording medium 1, it is not possible to record any more encrypted contents key.

Now, the optical disc recording/reproduction apparatus adapted to record the encrypted contents keys of as many users as the maximum number who are authorized to use a disc-shaped recording medium 31 that describes the maximum number of persons who can be authorized to use the recording medium as shown in FIG. 10 will be described by referring to FIGS. 11 through 13. Information on the maximum number of persons who can be authorized to use the disc-shaped recording medium 31 is written in the TOC region 32 of the recording medium 31.

Referring to FIG. 13, the optical disc recording/reproduction apparatus reads out the disc management information from the TOC recording region 32 by means of its recording/reproduction head 10 in Step S21. The addresses to be accessed for the first, second and third recording regions 32, 33 and 34 of the optical disc become known from the disc management information. The TOC recording region 32 also describes the maximum number of persons who can be authorized to use the recording medium 1. In other words, the optical disc recording/reproduction apparatus can specify the maximum number of persons who can be authorized to use the recording medium 1.

If the number of users who use the recording/reproduction apparatus does not exceed the maximum number, it identifies the position of the IC 35 that is the second recording region from the address known from the TOC and reads out the information S_{kc} that provides a basis for a contents key by using the IC information read section 37 from the identified position of IC 35 in Step S22.

In the next step, or Step S23, the user's identification information U read out by the identification information acquisition section 7 arranged on the replay button 8 is supplied to and acquired by the user information acquisition section 16 by way of the input terminal 15.

Then, in Step S24, the contents key k_{c} generation section 12 generates a contents key k_{c} from the information S_{kc} that provides a basis for the contents key. More specifically, the k_{c} generation section 12 can generate a contents key k_{c} from f_{kc}⁻¹(S_{kc}), using the inverse function f_{kc}⁻¹ of the above-described function f_{kc}.

In the next step, or Step S25, the contents key k_{c}′ generation section 13 generates an encrypted contents key k_{c}′, using the user identification information (user information) U. More specifically, the encrypted contents key k_{c}′ generation section 13 computes fₑ(U, k_{c}) to generate an encrypted contents key k_{c}′.

In the nest step, or Step S26, the encrypted contents key k_{c}′ recording section 14 writes the encrypted contents key k_{c}′ in the third recording region 34 at the address that is already known from the process of reading out the TOC in Step S21. As a result, the encrypted contents key k_{c}′ that is encrypted by means of the user's identification information (user information) is written on the disc-shaped recording medium 31.

After Step S26, this modified optical disc recording/reproduction apparatus returns to Step S21 and, if the number of users authorized to operate the disc recording/reproduction apparatus does not exceed the above-described maximum number, it repeats the Steps S22 through S26.

If it is determined that the number of users exceeds the above-described maximum number in Step S21, the disc recording/reproduction apparatus records the encrypted contents key k_{c}′ in the third recording region 34 in Step S26 and then destroys the above-described information S_{kc} that provides a basis for a contents key in the IC 35 in Step S27. For example, the data in the IC 35 can be destroyed by sending a predetermined instruction for erasing data to the IC 35 by means of a communication technique such as RF-ID and executing the predetermined instruction.

Thus, with the optical disc recording/reproduction apparatus, it is not possible to read out the information S_{kc} that provides a basis for a contents key when the number of users exceeds the number of persons who can be authorized to use it because the information S_{kc} that provides a basis for a contents key is destroyed or erased in Step 27 when the number of users exceeds the number of persons who can be authorized to use it. Therefore, if the recording/reproduction apparatus can authorize a plurality of users to use the disc-shaped recording medium 31, the information that provides a basis for contents key is protected.

The information on the number of persons who can be authorized to use the disc-shaped recording medium 1 may be encrypted and recorded in the second recording region 35. In any case, it is possible to record a plurality of encrypted contents keys that are encrypted by means of personal identification information of so many persons and so many contents keys in the disc-shaped recording medium 31 as shown in FIG. 10.

Now, two specific examples will be described below for the above modified embodiments. In the first specific example, the information S_{kc} that provides a basis for a contents key is not erased but maintained. The maximum number of persons for whom encrypted contents key k_{c}′ can be recorded in the third recording region 4 or 34 (to be referred to the recordable maximum number of persons hereinafter) is predetermined and greater than the maximum number of persons who can be authorized to use the disc-shaped recording medium. Users can be registered within the maximum number of persons who can be authorized to use the recording medium until the number gets to the recordable maximum number of persons. If it is desired to register one or more than one persons beyond the maximum number of persons who can be authorized to use the recording medium, one or more than one of the encrypted contents keys are erased by means of the users' personal identification information and their contents keys that are already recorded and then the encrypted contents keys of those new persons are recorded by means of the new persons' personal identification information and their contents keys. In this way, it is possible to replace users at any time within the maximum number of persons who can be authorized to use the recording medium. However, since the recordable maximum number of persons is predetermined and the number of persons that can be replaced is limited, it is possible to avoid a situation where the recording medium is assigned to an infinite number of persons.

In the second specific example, the maximum number of persons who can be authorized to use the recording medium is managed by using flags. More specifically, flags are recorded for the maximum number of persons who can be authorized to use the recording medium in the region 5 or 35 where the information S_{kc} that provides a basis for contents keys is written and a flag is erased when a new user is registered. Thus, when all the flags are erased, it is determined that the maximum number of persons who can be authorized to use the recording medium is reached.

In either of the two specific examples of the modified embodiments, the information S_{kc} that provides a basis for a contents key is destroyed or erased when the number of users gets to the maximum number of persons who can be authorized to use the recording medium.

The disc-shaped recording mediums 1 and 31 where the encrypted contents keys k_{c}′ of the maximum number of persons who can be authorized to use the recording medium are recorded by either of the modified embodiments of disc recording/reproduction apparatus is replayed by a disc replay apparatus as shown in FIG. 6. The disc replay apparatus generates a contents key from each of the encrypted contents keys k_{c}′, while acquiring the identification information U of the corresponding user, and decrypts the encrypted contents C_{E} by means of the contents key k_{c}.

The present invention is by no means limited to the above-described embodiments, which may be modified and altered in various different ways without departing from the spirit and scope of the invention as defined by the appended claims.

### INDUSTRIAL APPLICABILITY

Applications where a recording apparatus can be used as apparatus for writing user information include retailers selling disc-shaped recording mediums such as CD & DVD shops, where biometric identification information of each user is read out and used to generate an encrypted contents key, which is then written in a predetermined recording region of a recording medium according to the invention as user information.

When replaying the recording medium, a replay apparatus according to the invention acquires the biometric identification information and decrypts the encrypted contents key to obtain the corresponding contents key. Then, the contents key is used to decrypts the corresponding encrypted contents.

1. A recording medium bearing encrypted contents recorded thereon, the medium comprising:
a first recording region bearing the contents encrypted by a contents key and recorded therein;
a second recording region bearing a data providing a basis for the contents key and recorded therein;
a third recording region allowing the encrypted contents key obtained by encrypting the contents key generated from the data providing a basis for the contents key by means of identification information on a user to be recorded therein.

2. The recording medium according to claim 1, wherein the second recording region is a recordable region where data can be written only for once.

3. The recording medium according to claim 1, wherein the third recording region is a writable region.

4. The recording medium according to claim 1, wherein the recording medium is disc-shaped.

5. The recording medium according to claim 1, wherein the data that provides a basis for a contents key recorded in the second recording region is erasably recorded there.

6. The recording medium according to claim 5, wherein the data that provides a basis for a contents key as recorded in the second recording region is erased when a predetermined data is written there.

7. The recording medium according to claim 1, wherein the second recording region is formed by a semiconductor integrated circuit.

8. The recording medium according to claim 7, wherein the data that provides a basis for a contents key as recorded in the semiconductor integrated circuit of the second recording region is made unreadable when a predetermined instruction is executed.

9. The recording medium according to claim 1 or 7, wherein, information on the maximum number of persons who can be authorized to use the recording medium is described in the second recording region and the encrypted contents keys of a plurality of users exceeding the maximum number that are encrypted by means of the users' personal identification information and so many contents keys can be recorded there.

10. The recording medium according to claim 1 or 7, wherein, information on the maximum number of persons who can be authorized to use the recording medium is described in a management recording region of the recording medium and the encrypted contents keys of a plurality of users exceeding the maximum number that are encrypted by means of the users' personal identification information and so many contents keys can be recorded there.

11. A recording/reproduction apparatus for writing data on a recording medium bearing encrypted contents data recorded thereon, the apparatus comprising:
reproduction means for reproducing the data providing a basis for a contents key of the encrypted contents data recorded on the recording medium in advance by the contents key from a second recording region bearing a data providing a basis for the contents key;
contents key generation means for generating a contents key from the data providing a basis for a contents key;
acquisition means for acquiring identification information on a user authorized to reproduce the contents corresponding the contents data;
encrypted contents key generation means for generating an encrypted contents key encrypted by means of the generated contents key and the acquired identification information on the user; and
recording means for recording the generated encrypted contents key in a third recording region of the recording medium.

12. The apparatus according to claim 1, wherein the reproduction means reproduces the data that provides a basis for the contents key from the second recording region that is a recordable region where data can be written only for once.

13. The apparatus according to claim 11, wherein the recording means records the encrypted contents key in the third recording region that is a writable region.

14. The apparatus according to claim 11, wherein the reproduction means reproduces the data that provides a basis for the contents key as erasably recorded in the second recording region.

15. The apparatus according to claim 11, wherein the data that provides a basis for a contents key as recorded in the second recording region is erased when a predetermined data is written there.

16. The apparatus according to claim 11, wherein, information on the maximum number of persons who can be authorized to use the recording medium is described in the recording medium and the encrypted contents keys of a plurality of users exceeding the maximum number that are encrypted by means of the users' personal identification information and so many contents keys can be recorded in the third recording region by the recording means.

17. A replay apparatus for replaying a recording medium bearing encrypted contents data recorded thereon, the apparatus comprising:
first reproduction means for reproducing the encrypted contents data recorded in a first recording region of the recording medium;
second reproduction means for reproducing the encrypted contents key for decrypting the cryptogram of the encrypted contents, the encrypted contents key being recorded in a third recording region of the recording medium;
input means for inputting identification information on a user;
encrypted contents key decryption means for decrypting the contents key by means of the encrypted contents key and the identification information on the user; and
contents data decryption means for decrypting the encrypted contents data reproduced by the first reproduction means by means of the contents key decrypted by the contents key decryption means.
